(19) United States
(12) Patent Application Publication
(10) Pub. No.: US 2008/0229682 A1
(43) Pub. Date: Sep. 25, 2008

(54) ASEISMIC JOINT

(75) Inventor: DAVIDE TORSANI, Rimini (IT)

Correspondence Address: PEARNE & GORDON LLP, 1801 EAST 9TH STREET, SUITE 1200, CLEVELAND, OH, 44114-3108, US

(73) Assignee: KIVATEC S.R.L., MILANO (MI) (IT)

(21) Appl. No.: 12/042,630

(22) Filed: Mar. 5, 2008

(30) Foreign Application Priority Data
Mar. 22, 2007 (IT) MI2007A000570

(51) Int. Cl. E04B 1/98; E04H 9/02; F16F 7/12

(52) U.S. Cl. 52/167.1; 267/141; 403/220

(57) ABSTRACT

A seismic joint, for covering a gap (4) defined between a first (2) and a second (3) structural element, comprises: a first anchoring portion (6a) to be steadily associated with the first structural element (2); a first interconnecting portion (6b) rotatably connected to the first anchoring portion (6a); a covering element (5) having a first end (5a) rotatably in engagement with the interconnecting element (6b) and a second end (5b) able to be engaged in a slidably supported relationship on the second structural element (3).

### FIELD AND BACKGROUND OF THE INVENTION

The present invention relates to an aseismic joint, and applies to the sector of building constructions adapted to withstand seismicphenomena.

In more detail, the invention relates to a joint used for connecting the structural elements of a building such as floors, slabs, or more generally masonry works to each other, in such a manner that a structural continuity is ensured between the structural elements themselves on occurrence of stresses transmitted to the building by seismic phenomena.

It is to be pointed out that structural elements in constructing aseismic buildings cannot be rigidly connected to each other. It is in fact known that structural elements are made of materials with a weak elasticity such as bricks and tiles, concrete, reinforced concrete. Due to the low elasticity shown, these structural elements when submitted to vibratory phenomena and in particular low-frequency and medium-high-amplitude oscillations are subjected to cracking, permanent damages or even structural yielding.

Therefore, often provided between the different structural elements are gaps adapted to enable mutual movements between the structural elements themselves so as to allow each individual structural element to shift and settle in a manner independent of the other structural elements adjacent thereto.

These gaps can also be provided between the whole construction and the surrounding environment; let us think for instance of the necessity to seismically isolate a building relative to the walls of the excavation in which the building is partly buried or relative to an adjacent road paving.

Said gaps give rise to even important size discontinuities between the different structural elements of the building that can cause risks to users who have to operate or move in close proximity to these discontinuities.

Therefore aseismic joints are known which act between two structural elements of a building for connecting the same to each other thus eliminating the risks for the users who would find themselves to operate or move in close proximity to said gaps.

These joints generally comprise a covering element extending between two structural elements that are separated by the gap. The covering element is movable relative to the structural elements so as to absorb displacements between the same.

As disclosed in US2002/054785, the covering element is positioned at the gap to be covered, and is supported at the lower part thereof, at a centered position, by a plurality of bars that are rotatably connected to the lower part of the covering element and are slidably inserted at their ends into grooves of the structural elements, which grooves extend longitudinal to the gap. As the mutual distance between the structural elements varies, there is a variation in the gap size and the bars vary their angle within the gap relative to the ends of the structural elements, while they go on bearing the support element.

Slidable coupling between the ends of the bars and the grooves is obtained by ball-shaping the ends of the bars and shaping the cross section of the grooves in the form of an arc of a circumference, so that the ball-shaped ends of the bars are correctly guided by the grooves.

The joint of the above described type however has some drawbacks.

Conformation of the bars with said ball-shaped ends makes the same only suitable for absorbing displacements along a moving-apart or moving-close direction of the structural elements. In fact, in the event of strong misalignments between the two structural elements, which are characteristic of seismic phenomena, the bars would be submitted to an excessive inclination which would lead them to interfere with the guides defining said grooves and to impact on same.

In addition, due to the covering element resting on a limited number of bars, the covering element may be unsuitable for supporting high loads or being used for going over gaps having important sizes.

A further drawback is given by the necessity to take into account expensive working operations for manufacturing the ball-shaped ends of the bars and the grooves of circular cross section. The ball-shaped ends of the bars and the grooves must in fact be coupled with accuracy and the risk of the ends jamming in the grooves must be eliminated also when strong external loads are applied.

In addition, a joint of the above described type is unsuitable for creating a waterproofing effect between the gap and the space overlying the joint. In fact the covering element merely slidably resting on the two structural elements does not prevent leakage of fluids, in particular liquids, towards the gap, and therefore the structure of the joint resulting therefrom is not suitable for being correctly used in buildings for civil use or habitation where adjacent or superposed spaces are to be isolated from each other.

### OBJECTS

It is a technical task of the present invention to make available an aseismic joint that is free from the above mentioned drawbacks.

Within the scope of this technical task, it is a main aim of the invention to make available an aseismic joint enabling misalignment between two structural elements, i.e. raising of the two structural elements relative to each other, to be absorbed.

In addition, it is an important aim of the invention to make available an aseismic joint enabling displacements to be absorbed when they take place between two structural elements along a direction substantially parallel to an extension direction of the gap present between the two structural elements.

It is a further important aim of the invention to make available an aseismic joint allowing displacements between two structural elements along a moving-close and moving-away direction of same to be absorbed.

A still further aim of the invention is to provide an aseismic joint that is of simple and cheap construction and has a high structural solidity.

It is also an important aim of the invention to make available an aseismic joint facilitating achievement of a satisfactory waterproofing effect between the gap and a space overlying the joint itself.

Another aim of the invention is to provide an aseismic joint having such a surface finish as to define an even extension of pre-existing surfaces, i.e. a surface finish avoiding unevennesses and/or steps in the treading plan between the joint and one or more walkable surfaces adjacent to the joint.

### SUMMARY OF THE INVENTION

The foregoing and still further aims that will emerge in the following of the present description are substantially achieved by an aseismic joint having the features set out in claim 1 and/or in one or more of the claims dependent thereon.

### BRIEF DESCRIPTION OF THE DRAWINGS

A preferred but not exclusive embodiment of an aseismic joint in accordance with the present invention is now illustrated by way of non-limiting example with the aid of the accompanying drawings, in which:

FIG. 1 shows a side view of an aseismic joint in accordance with the present invention, in a normal-use configuration;

FIG. 2 is an enlarged section of a first detail of the joint seen in FIG. 1;

FIG. 3 is an enlarged section of a second detail of the joint in FIG. 1, in accordance with a first embodiment;

FIG. 4 is an enlarged section of the second detail seen in FIG. 3, in accordance with a second embodiment;

FIGS. 5a-5d are side views of a sequence of configurations that the joint seen in FIG. 1 can take by effect of a seismic event;

FIGS. 6a, 6b are plan views of a portion of a building having a joint of the invention, in a first mounting mode of same and according to two operating configurations different from each other;

FIGS. 7a, 7b are plan views of a portion of a building having a joint of the invention, in a second mounting mode of same and according to two operating configurations different from each other;

FIG. 8 is a perspective view of a covering element being part of the joint according to the invention.

### DESCRIPTION OF THE PREFERRED EMBODIMENT

In accordance with the accompanying figures, an aseismic joint in accordance with the present invention has been generally denoted at 1.

Joint 1 can be used in the sector of building and/or civil constructions, such as buildings, infrastructures, public or private works, and more generally constructions in which adoption of aseismic-prevention expedients are required.

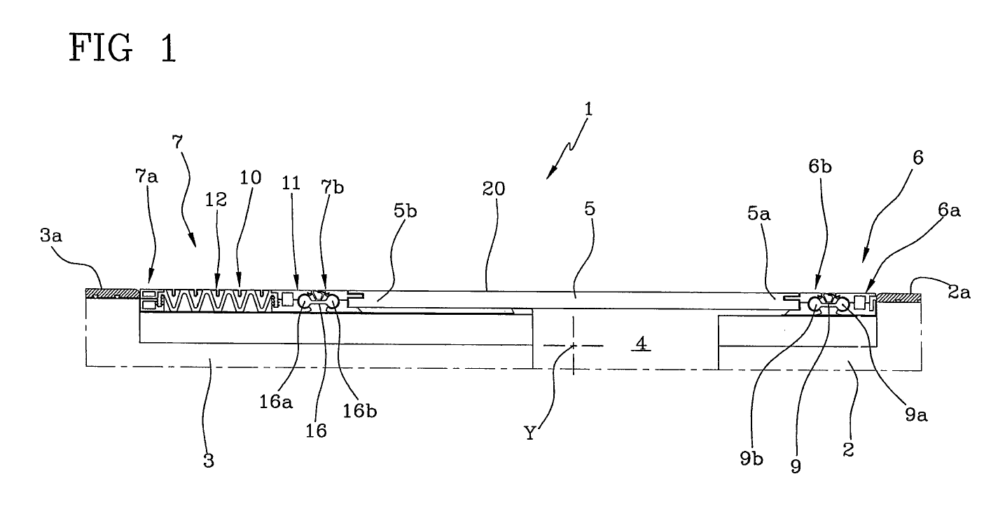

In accordance with the view in FIG. 1, joint 1 is used in connection with a pair of structural elements 2, 3 such as two slabs of a building construction, which are separated from each other by a gap 4 the function of which, as already said, is to enable each structural element 2, 3 to shift independently of each other.

In the application in question, joint 1 defines a cover for gap 4 and, more preferably creates a continuity between the upper surfaces 2a, 3a of the structural elements 2, 3. When the upper surfaces 2a, 3a are walkable surfaces, such as in the case shown, joint 1 will form a bridge element suitable for bearing stresses due to passage of persons or machinery traveling over the gap 4.

Joint 1 comprises a covering element 5, preferably a flat panel and more preferably a section member extending between the two structural elements 2, 3 in such a manner that it has one end 5a facing the first one 2 of said structural elements 2, 3 and the second end 5b opposite to the first one 5a facing the second structural element 3.

Ends 5a, 5b of the covering element are preferably above the respective structural elements 2, 3 while a central portion 5c of the covering element 5 is over gap 4 and forms a cover therefor.

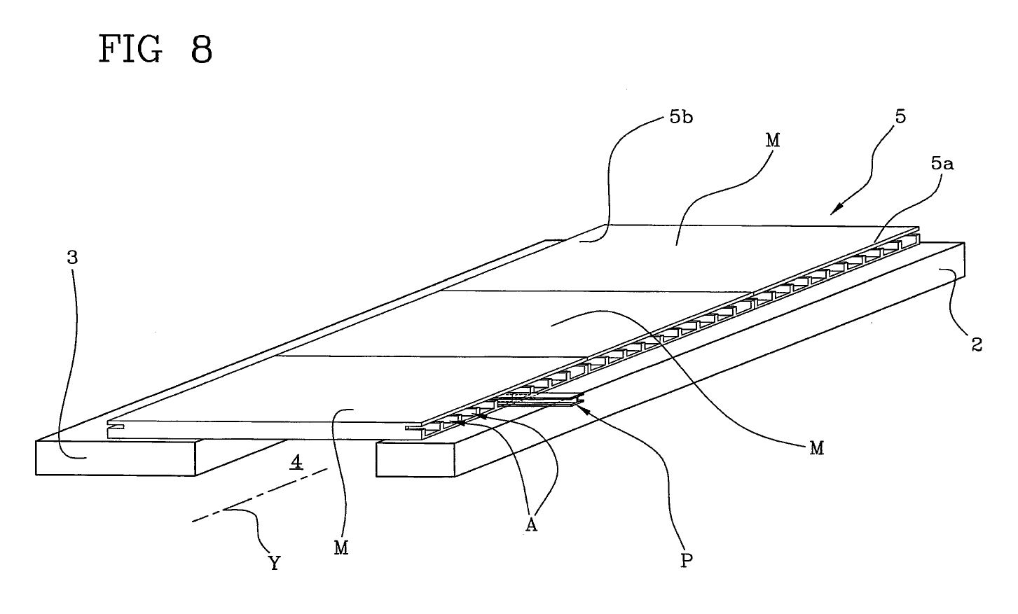

As shown in FIG. 8, the covering element 5 can consist of a plurality of modules “M” disposed consecutively close to each other along a major extension direction “Y” of gap 4, i.e. transversely of a mutual moving-close and/or moving-away direction of the structural elements 2, 3. Modules “M” can advantageously be obtained by cutting segments of the desired length from a continuous section member, said length being selected depending on the gap 4 clearance resulting from the distance between the structural elements 2, 3. It is thus possible to obtain covering elements of the desired sizes depending of the gap 4 sizes, from a single section member.

Each module “M” internally has a plurality of housings “A” extending between the first 5a and second 5b ends of the covering element and accessible by at least one of said ends 5a, 5b. These housings “A” are adapted to engage respective stiffening elements, preferably metal section bars “P”, such as IPE beams, to be used when joint 1 is to be employed in situations requiring high loads to be borne and/or when gaps 4 have big clearances.

The joint further comprises a first connecting member 6 acting between the first structural element 2 and the first end 5a of the covering element 5 to kinematically connect the latter to said first structural element 2.

On the opposite side, joint 1 comprises a second connecting member 7 acting between the second structural element 3 and the second end 5b of the covering element 5 to kinematically connect the latter to said second structural element 3.

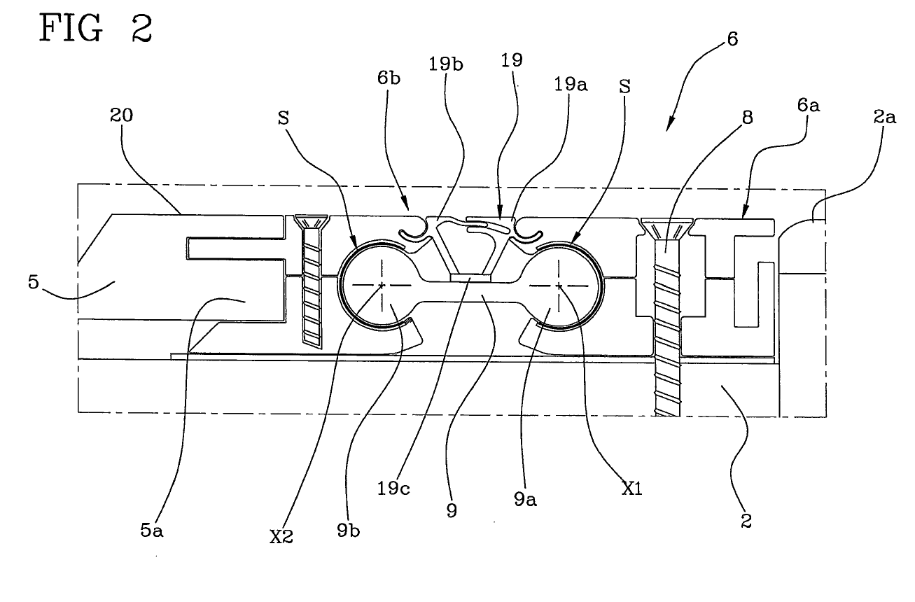

The first and second connecting members 6, 7 comprise a first anchoring portion 6a and a second anchoring portion 7a respectively, which can be steadily associated with the respective structural element 2, 3 by means of one or more screw threaded elements 8, for example. Only one of said threaded elements 8, and in particular the one relating to the anchoring portion 6a, is shown in FIG. 2.

The first and second connecting members 6, 7 further comprise a first interconnecting portion 6b and a second interconnecting portion 7b respectively, which act between the corresponding anchoring portion 6a, 7a and the respective end 5a, 5b of the covering element 5 to connect the covering element 5 to said anchoring portions 6a, 7a and so to the structural elements 2, 3.

In more detail, the first interconnecting portion 6b comprises a first connecting-rod element 9 having a first end 9a hinged on the first anchoring portion 6a, and a second end 9b, opposite to the first one 9a, which is hinged on the first end 5a of the covering element 5. Said first 9a and second 9b ends of the first connecting-rod element 9 therefore define as many connecting hinges between the first connecting-rod element 9 and the first anchoring portion 6a and the first end 5a of the covering element 5, respectively.

The first connecting-rod element 9 and the first anchoring portion 6a can therefore rotate relative to each other around a first rotation axis “X1” that is fixed relative to the first structural element 2, as shown in FIG. 2. In addition, the first connecting-rod element 9 and the first end 5a of the covering element 5 can rotate relative to each other around a second rotation axis “X2” which is not coincident with the first rotation axis “X1”. Preferably, the first “X1” and second “X2” rotation axes are parallel to each other, and more preferably are parallel to the major extension direction “Y” of gap 4. In other words, the first “X1” and second “X2” rotation axes are transverse to a mutual moving-close and/or moving-away direction of the two structural elements 2, 3. According to the preferred embodiment of joint 1 of the invention, said first “X1” and second “X2” rotation axes are parallel to a major extension direction of the covering element 5 of joint 1, and are preferably oriented parallel to a longitudinal edge carried by the first end 5a of the covering element 5.

Due to the presence of the first connecting-rod element 9, a plurality of rotational and/or translational movements of the covering element 5 relative to the first structural element 2 are allowed, as well as raising and/or lowering movements relative to the second structural element 3.

The second connecting member 7 comprises an extendible insert 10 operatively interposed between the second anchoring portion 7a and the second end 5b of the covering element 5 to absorb displacements of the latter close to and/or away from the second structural element 3. Following this displacement, the extendible insert 10 absorbs the distance variation generated between the second end 5b of the covering element 5 and the second anchoring portion 7a, to be rigidly coupled to the second structural element 3.

From an operating point of view, the extendible insert 10 defines an extension of the covering element 5 in such a manner as to form, in connection with the latter and with the upper surfaces 2a, 3a of the structural elements 2, 3, a substantially even and continuous surface substantially free from raised portions, steps or discontinuities.

The second interconnecting portion 7b comprises a movable element 11 which is slidably supported on the second structural element 3 for movement close to and/or away from the first structural element 2.

The extendible insert 10 is directly connected, at an end thereof, to the second anchoring portion 7a, while it is directly connected, at the opposite end, to the movable element 11.

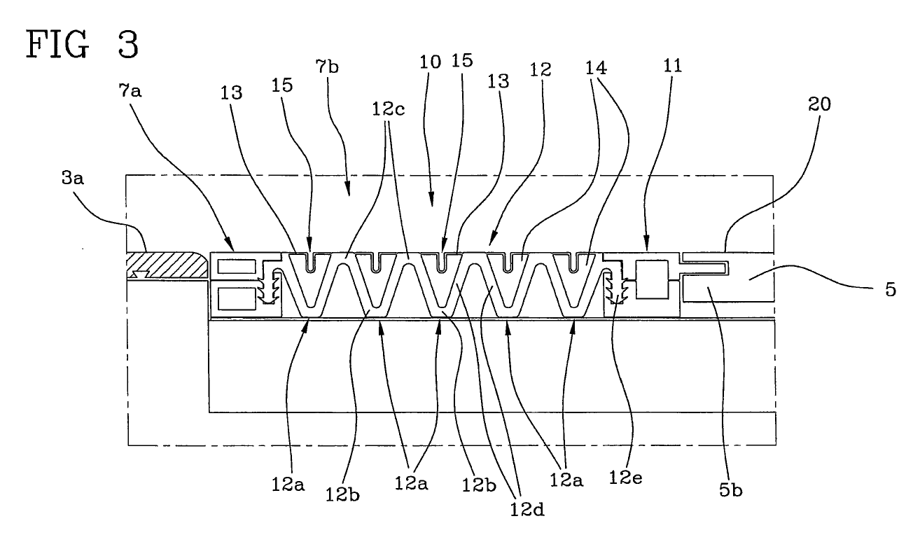

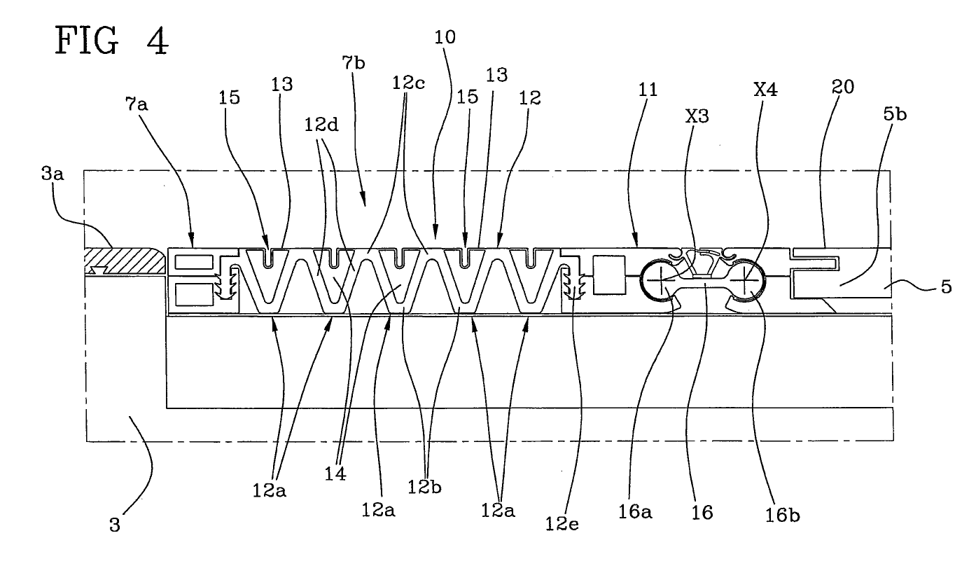

According to a preferred embodiment of the invention and as shown in detail in FIGS. 3 and 4, the extendible insert 10 comprises a concertina-shaped element 12, of the elastically-deformable type and preferably made of elastomeric material. The concertina-shaped element 12 is adapted to extend and shorten to follow the mutual approaching and departing movements between the second anchoring portion 7a and the movable element 11.

The concertina-shaped element 12 comprises a main portion having an undulating profile giving the concertina-shaped element 12 a high resistance to squashing along a direction perpendicular to a compacting direction of same, i.e. along a direction transverse to the moving-close and/or moving-away direction of the two structural elements 2, 3. This enables the concertina-shaped element 12 to be able to define a strong walkable base for users who are moving on joint 1.

In accordance with the embodiments shown in FIGS. 3 and 4, the main undulating-profile portion of the concertina-shaped element 12 comprises a succession of modules 12a mutual compacting of which causes a reduction in length of the concertina-shaped element 12. In particular, each module 12a has a bottom 12b and a ridge 12c, joined together by inclined walls 12d which, in co-operation with said ridges 12c and bottoms 12b, define the main undulating-profile portion of the concertina-shaped element 12.

The concertina-shaped element 12 further comprises at least one auxiliary portion 13 extending on one side of the main portion to define a surface substantially in coplanar relationship with an outer surface 20 of the covering element 5.

In more detail, each module 12a is associated with a respective auxiliary portion 13 which has a lower thickness than the thickness of the main portion and is located at the ridge 12c of said module 12a.

Ridges 12c of successive modules 12a are mutually connected by successive auxiliary portions 13 hindering entrance and accumulation of dust and dirt into the spaces 14 defined between the inclined walls 12d of each module 12a.

Preferably, the auxiliary portions 13, made of elastically deformable material, in particular elastomeric material, can be deformed in order to enable mutual moving close and/or moving apart of the ridges 12c of modules 12a in such a manner as not to inhibit extensibility of the concertina-shaped element 12.

To promote extensibility of the auxiliary portions 13, each of them has a curved central portion 15, preferably facing the respective space 14 which is suitable for deformation to enable a length increase of the auxiliary portion 13 itself and/or spring back of same during elongation and shortening movements of the concertina-shaped element 12.

According to a first embodiment of the invention shown in FIG. 3, the movable element 11 is directly connected, preferably in a stiff manner, to the second end 5b of the covering element 5. Under this circumstance, possible oscillating movements of the covering element 5 relative to the second anchoring portion 7a, and therefore to the second structural element 3, are allowed due to deformability of the concertina-shaped element 12 that is able to bear bending deformations of its own at least at an end thereof connected to the movable element 11. In particular, the concertina-shaped element 12 has a curved end 12e which is insertable by friction fit into a corresponding seat of the movable element 11.

In accordance with a second embodiment of the invention, shown in FIG. 4, the second interconnecting portion 7b comprises a second connecting-rod element 16 operatively acting between the movable element 11 and the second end 5b of the covering element 5 to allow relative rotations between the latter, even of high extent.

In accordance with the view in FIG. 4, the second connecting-rod element 16 has a first end 16a hinged on the movable element 11, and a second end 16b, opposite to the first one 16a, hinged on the second end 5b of the covering element 5. Said first 16a and second 16b ends of the second connecting-rod element 16 therefore define as many connecting hinges between the second connecting-rod element 16 and the movable element 11 and second end 5a of the covering element 5, respectively.

Under this circumstance, the first 16a and second 16b ends of the second connecting-rod element 16 rotate around a third “X3” and a fourth “X4” rotation axis respectively, which axes are different from each other and are both movable depending on the configuration taken by joint 1.

Preferably, the third “3” and fourth “X4” rotation axes are parallel to each other and more preferably are parallel to said major extension direction “Y” of gap 4.

In accordance with a preferred embodiment of joint 1 according to the invention, said third “X3” and fourth “X4” rotation axes are parallel to a major extension direction of the covering element 5 of joint 1 and are preferably oriented parallel to a longitudinal edge carried by the second end 5b of the covering element 5.

Attention will be now focused on the two connecting-rod elements 9, 16 which allow joint 1 in accordance with the invention to achieve a high versatility degree as regards absorption of displacements connected with seismic activities.

The ends 9a, 9b of the first connecting-rod element 9 and the ends 16a, 16b of the second connecting-rod element 16 have a cross-section profile of a substantially circular conformation. Correspondingly, the first anchoring portion 6a and the first end 5a of the covering element 5, as well as the movable element 11 and the second end 5b of the covering element 5, have first and second seats 17, 18 respectively of circular section having a profile the shape of which substantially matches the shape of the corresponding ends 9a, 9b, 16a, 16b of the connecting-rod elements 9, 16.

Advantageously, between the first 17 and second 18 seats and the corresponding ends 9a, 9b, 16a, 16b of the connecting-rod elements 9, 16 fitted therein, at least one insert “S” made of a non-stick material, preferably PTFE, is interposed.

As shown in the enlarged view in FIG. 2, the first connecting-rod element 9 is associated with a first seal 19 creating an isolation between the first connecting-rod element 9 and the outer surface 20 of the covering element 5 and, more preferably, of the whole joint 1. Said first seal 19 extends between portions facing each other of the first end 5a of the covering element 5 and the first anchoring portion 6a.

In addition, the first seal 19 preferably comprises two half-lips 19a, 19b each of which is steadily associated with one of the two mentioned facing portions of the first end 5a of the covering element 5 and the first anchoring portion 6a. The two half-lips 19a, 19b overlap each other at least partly to enable the first seal 19 to absorb mutual displacements between said facing portions following a rotation and/or translation of the covering element 5. The two half-lips 19a, 19b have a common portion 19c keeping the two half-lips 19a, 19b mutually coupled.

A second seal 21, quite identical with the first seal 19, is placed at the second connecting-rod element 16 and, therefore, acts between the facing portions of the movable element 11 and of the second end 5b of the covering element 5.

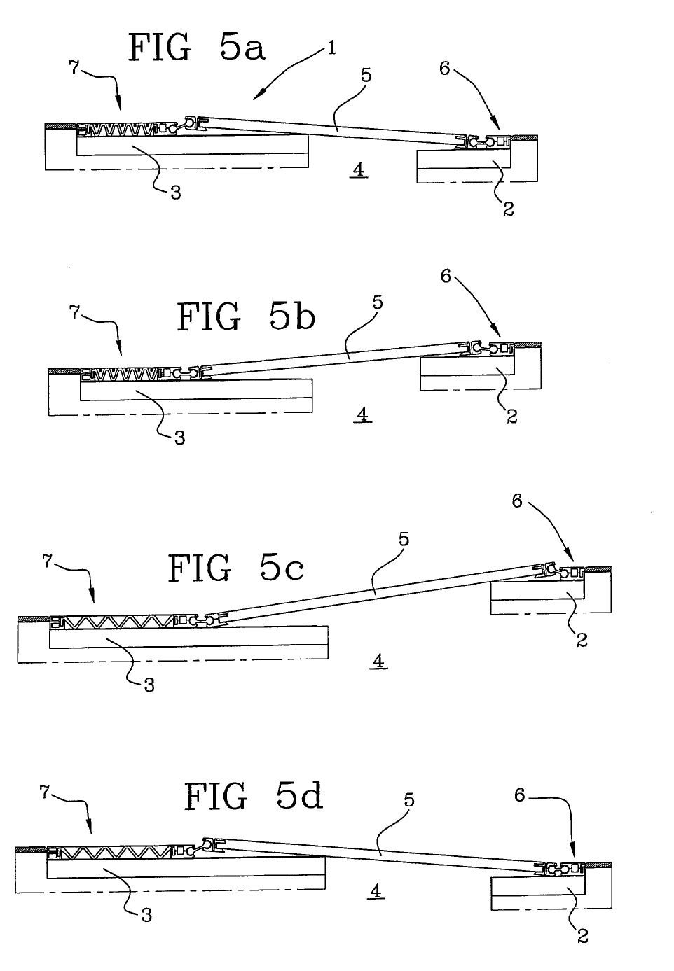

In FIGS. 5a to 5d four views of joint 1 in accordance to the invention are shown, in different operating configurations. In each of them it is possible to see that the connecting-rod elements 9, 16 define, in co-operation with the covering element 5, a four-bar-linkage adapted to allow movement of the covering element 5 in a plurality of configurations that are rotated and/or translated relative to each other following misalignments between the structural elements 2, 3. In this context “misalignments” means raising of the two structural elements 2, 3 relative to each other that will cause a difference in height between the respective upper surfaces 2a, 3a.

Said movements of the covering element 5 are also promoted by the presence of the extendible insert 10 allowing also important displacements of the two structural elements 2, 3 close to and away from each other to be absorbed.

Advantageously, the connecting-rod elements 9, 16 as well as the connecting members 6, 7 consisting of extruded section bars made of an aluminum alloy for example, extend according to a constant cross-section profile over the whole dimension of the covering element 5 along the major extension direction of gap 4 or preferably along the whole dimension in length of the covering element 5. As a result, both the ends 9a, 9b, 16a, 16b of the connecting-rod elements 9, 16 and the respective seats 17, 18 have a cylindrical conformation and are slidably in engagement with each other along a direction parallel to the respective hinging axes. This enables joint 1 as conceived, in addition to reaching the parallelism between the rotation axes “X1”, “X2”, “X3”, “X4”, to absorb mutual displacements between the structural elements 2, 3 also along a direction parallel to the major extension direction “Y” of gap 4, i.e. along a direction parallel to said rotation axes “X1”, “X″”, “X3”, “X4”. In this connection, use of said insert “S” of non-stick material in co-operation with the connecting-rod elements 9, 16 facilitates relative sliding between the ends 9a, 9b, 16a, 16b of the connecting-rod elements 9, 16 and the respective seats 17, 18.

Preferably, the anchoring portions 6a, 7a and in addition the interconnecting portions 6b, 7b are mounted on the structural elements 2, 3 in such a manner that said longitudinal extension direction of same is parallel to the major extension direction “Y” of gap 4.

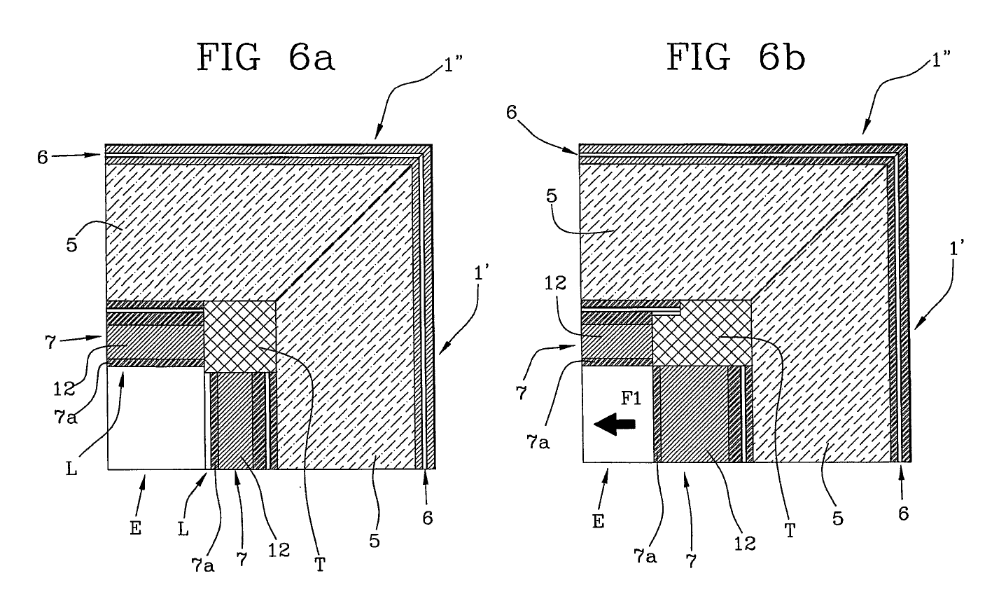

FIG. 6a shows a plan view of a portion of a building “E”, in which a pair of joints 1′, 1″ in accordance with the present invention is used. These joints 1′, 1″ are utilized on two perimetral sides “L” perpendicular to each other of building “E”.

In particular, in accordance with the above description, it is pointed out that the first connecting member 6 of each joint 1′, 1″ faces a peripheral portion of building “E”, while the corresponding second connecting member 7 faces an inner portion of building “E”. It is also to be noted the presence of the concertina-shaped element 12, which is submitted to stretching in the direction of arrow “F1” on passing from the starting configuration in FIG. 6a to the operating configuration in FIG. 6b, following a telluric movement, for example. As a result of displacement along arrow “F1” of FIG. 6b, joint 1″ not concerned with such stretching can slide without being elastically deformed due to said possibility of translation of the connecting-rod elements 9, 16 in the respective seats 17, 18.

In FIGS. 6a, 6b and in particular in a space portion adjacent to the second connecting members 7 of joints 1′, 1″, the presence of an elastic mat “T” is shown which absorbs deformations along any direction belonging to the plane of the mat itself, and completes a structural-continuity effect of the deformed joints 1′, 1″.

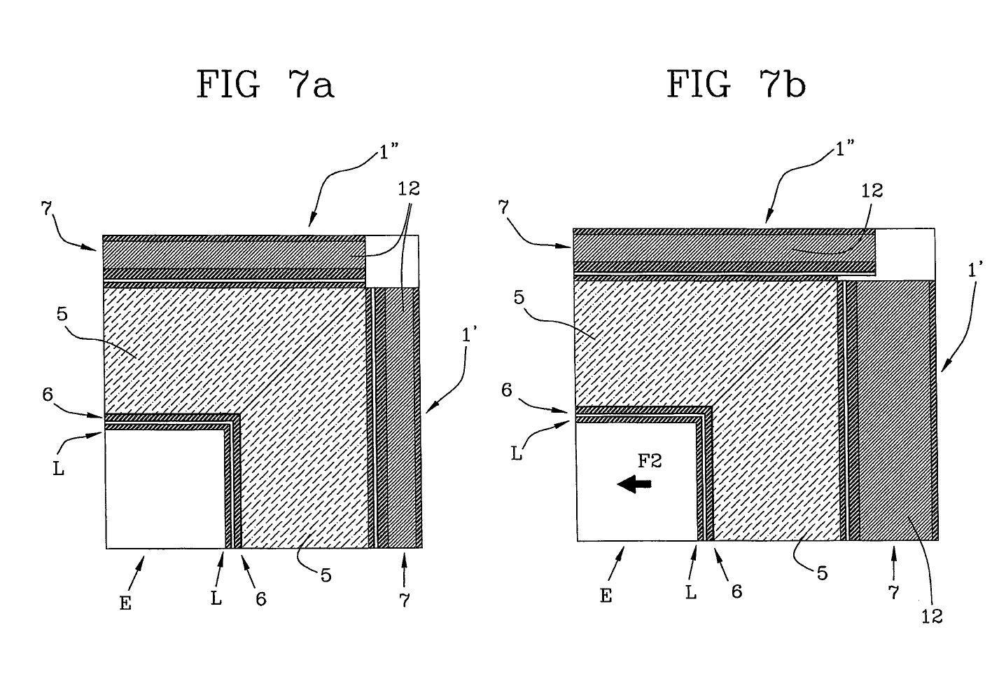

In accordance with the view in FIG. 7a, the first connecting member 6 of each of the two joints 1′, 1″ faces an inner portion of building “E”, while the corresponding second connecting member 7 faces a peripheral portion of building “E”. In this case too, following a force applied in the direction of arrow “F2” in FIG. 7b, stretching of the concertina-shaped element 12 of a first one 1′ of the two joints 1′, 1″ occurs, while the other joint 1″ slides in the direction of said arrow without being submitted to elastic deformation.

A joint 1 thus conceived and employed also enables a waterproofing action towards the underlying gap 4 to be carried out. This waterproofing action is above all linked to the presence of the concertina-shaped element 12 which is made of an elastomeric material and is not provided with openings that would allow liquid passage or leakage. In addition, due to the presence of inserts “S” made of PTFE, the hinges of the connecting-rod elements 9, 16 are fluid-tight, so that they help in accomplishing said waterproofing action.

It is also to be pointed out that the joint in question has a suitably reduced thickness, that will enable installation, in case of need, of additional waterproofing layers in the slabs or the walls where it is installed.

What is claimed is:

1. An aseismic joint for covering a gap (4) defined between a first (2) and a second (3) structural element, comprising:
a first anchoring portion (6a) steadily associable with the first structural element (2);
a first interconnecting portion (6b) rotatably connected to said first anchoring portion (6a);
a covering element (5) having a first end (5a) to be engaged close to the first structural element (2) and a second end (5b) to be engaged in slidably supported relationship on the second structural element (3);
wherein the first end (5a) of the covering element (5) is rotatably connected to the first interconnecting portion (6b).

2. The joint as claimed in claim 1, wherein the first interconnecting portion (6b) is hinged on the first anchoring portion (6a) through a first hinge and is further hinged on the first end (5a) of the covering element (5) by a second hinge, said first and second hinges defining a first (X1) and a second (X2) rotation axis respectively, that are parallel to each other.

3. The joint as claimed in claim 1, wherein at least one of said covering element (5) and first anchoring portion (6a) slidably engages the first interconnecting portion (6b) in a direction parallel to a respective hinging axis of the first interconnecting portion (6b) itself.

4. The joint as claimed in claim 1, wherein at least one of said covering element (5) and first anchoring portion (6a) carries a cylindrical seat (17) rotatably engaging one cylindrical end (9a, 9b) carried by the first interconnecting portion (6b).

5. The joint as claimed in claim 4, further comprising at least one insert (S) of non-stick material operatively interposed between said cylindrical seat (17) and said cylindrical end (9a, 9b).

6. The joint as claimed in claim 1, wherein said first anchoring portion (6a) has a constant cross-section profile along a longitudinal extension direction thereof.

7. The joint as claimed in claim 1, wherein said first interconnecting portion (6b) has a constant cross-section profile along a longitudinal extension direction thereof.

8. The joint as claimed in claim 1, wherein said first anchoring portion (6a) and first interconnecting portion (6b) substantially extend over the whole length dimension of said covering element (5).

9. The joint as claimed in claim 2, wherein said rotation axes (X1, X2) are oriented parallel to a longitudinal edge carried by the covering element (5) at the first end (5a).

10. The joint as claimed in claim 1, wherein said first interconnecting portion (6b) comprises a first connecting-rod element (9) having ends (9a, 9b) that are rotatably connected to said first anchoring portion (6a) and to said covering element (5), respectively.

11. The joint as claimed in claim 1, further comprising:
a second anchoring portion (7a) steadily associable with the second structural element (3);
an extendible insert (10) operatively interposed between the second anchoring portion (7a) and the second end (5b) of the covering element (5).

12. The joint as claimed in the preceding claim, wherein said extendible insert (10) comprises a concertina-shaped element (12) made of elastomeric material.

13. The joint as claimed in claim 12, wherein said concertina-shaped element (12) comprises a main portion having an undulating profile and at least one auxiliary portion (13) of a smaller thickness than that of the main portion and extending on one side of the main portion itself so as to define a surface that is substantially coplanar with an outer surface (20) of the covering element (5).

14. The joint as claimed in claim 11, further comprising at least one second interconnecting portion (7b) rotatably connected both to the covering element (5) and the extendible insert (10).

15. The joint as claimed in claim 14, wherein said second interconnecting portion (7b) is hinged relative to the extendible insert (10) through a third hinge and is further hinged on the second end (5b) of the covering element (5) by a fourth hinge, said third and fourth hinges defining a third (X3) and a fourth (X4) rotation axis respectively, that are parallel to each other.

16. The joint as claimed in claim 14, wherein at least one of said covering element (5) and extendible insert (10) slidably engages the second interconnecting portion (7b) in a direction parallel to a respective hinging axis of the second interconnecting portion (7b) itself.

17. The joint as claimed in claim 16, wherein at least one of said covering element (5) and extendible insert (10) carries a cylindrical seat (18) slidably engaging a cylindrical end (16a, 16b) carried by the second interconnecting portion (7b).

18. The joint as claimed in claim 15, wherein said third (X3) and fourth (X4) rotation axes are oriented parallel to a longitudinal edge carried by the covering element (5) at the second end (5b).

19. The joint as claimed in claim 14, wherein said second interconnecting portion (7b) comprises a second connecting-rod element (16) having ends (16a, 16b) rotatably connected to said extendible insert (10) and said covering element (5), respectively.

20. The joint as claimed in claim 1, wherein the covering element (5) comprises a plurality of modules (M) disposed consecutively close to each other along a direction parallel to a hinging axis between the first interconnecting portion (6b) and the first anchoring portion (6a).

21. The joint as claimed in claim 1, wherein the covering element (5) internally has a plurality of housings (A) extending between the first (5a) and second (5b) ends of the covering element for engagement of respective stiffening elements (P).
